(19) United States
(12) Patent Application Publication
(10) Pub. No.: US 2013/0332288 A1
(43) Pub. Date: Dec. 12, 2013

(54) ADVERTISING MEDIA AND METHOD OF ADVERTISING

(71) Applicants: Thomas C. Garmon, Cleveland, TN (US); Jonathan W. Cutrell, Cleveland, TN (US)

(72) Inventors: Thomas C. Garmon, Cleveland, TN (US); Jonathan W. Cutrell, Cleveland, TN (US)

(21) Appl. No.: 13/708,171

(22) Filed: Dec. 7, 2012

Related U.S. Application Data
(63) Continuation of application No. 13/490,710, filed on Jun. 7, 2012, now abandoned.

(51) Int. Cl. G06Q 30/02

(52) U.S. Cl. CPC G06Q 30/0241
USPC 705/14.69

(57) ABSTRACT

In one embodiment, the present application provides a method of distributing downloadable media, comprising collecting a plurality of downloadable media files from a plurality of artists, at least one of the downloadable media files being associated with an item of visual artwork; receiving from an advertiser an order for promotional services; selecting at least one downloadable media file to associate with said advertiser; creating a modified item of visual artwork by adding an advertising message relating to the advertiser to the item of visual artwork associated with the selected downloadable media file; collecting demographic information about a recipient; delivering to the recipient a downloadable copy of the downloadable media tile and the modified item of visual artwork containing the advertising message; and charging a fee to the advertiser.

### CROSS-REFERENCE TO RELATED APPLICATIONS

This application claims priority to, and the benefit of, U.S. Provisional Application No. 61/494,396, filed Jun. 7, 2011 entitled “Advertising Media and Method of Advertising” and is a continuation of and therefore also claims priority to, and the benefit of, U.S. Non-Provisional application Ser. No. 13/490,710, filed Jun. 7, 2012.

### FIELD OF THE DISCLOSURE

The present disclosure relates generally to advertising media and a method of advertising. Exemplary uses of the disclosure include advertising disseminated in connection with non-streaming music distribution, although the use is not necessarily limited to non-streaming embodiments.

### BACKGROUND

Monetizing investment and creativity in music and other artistic efforts is becoming increasingly challenging. With the rise of the Internet and file sharing services, the music industry faces a world in which its ability to police the copying and distribution of copies of artistic works is thwarted by new technologies daily. Music and other artistic works are so rapidly and freely posted to file sharing, bit torrent, and other sites and venues that even law abiding consumers are being trained to expect music to be available for free. It is thus increasingly difficult to recoup the cost of bringing a new artist to market.

A way is needed to monetize the copying and distribution of music and other artistic works that does not depend on the willingness of the consumer to pay funds at the time of receipt of a copy. This disclosure addresses that need, among others.

In the past the broadcast television industry and the radio industry addressed this need by virtue of the fact that their audience listened “live,” and therefore advertisers would pay for space or time to present their advertisements to those eyes and ears that were paying attention during live broadcasts. In the Internet era, streaming music services such as Pandora and others have leveraged the same model, displaying advertisements that consumers would see as they pay attention to the live stream. However, these solutions are by their nature generally inapplicable to media that is not delivered in a stream or broadcast. Left unaddressed until now is the need to monetize downloadable content, such as music files.

The average person sees thousands of ads per day. Statistics suggest that a very high percentage of music downloads are pirated illegally. Consequently, there is a long-felt but unmet need for advertising for non-streaming media (although the use of this disclosure is not necessarily limited to non-streaming embodiments).

### BRIEF SUMMARY

The needs described above, as well as others, are addressed by certain embodiments of the media and methods described herein.

Generally described, the inventors have developed a method for monetizing the downloads of non-streamed media, such as MP3 audio files. Taking MP3 audio files as an example for discussion purposes (and not intending to limit the disclosure to those particularly); this disclosure as amplified below teaches the monetizing of file downloads by way of embedding advertising messages within the album cover art. An advertiser (or other entity that wants to disseminate a message) pays to have advertisements associated with MP3 downloads. The advertisements are added to album cover art prior to or at the time of download. In this way, the artist (or producer, or music label) receives payment for the download, even if the user that downloads the file does not want to pay for the file. Because the message is embedded with the album art, when the downloading user (or anyone else that gets the file from that user) loads the MP3 into any typical audio player, he or she will be faced with the advertisement. In this way, the advertiser receives the benefit of the advertisement, even when the file is later pirated. Accordingly, both the artist and the advertiser have monetized the download, even when payment is not made by the downloading user. Additionally, an entity practicing the disclosure can stand between the advertiser and the artist (or label or producer), to manage the embedding of messages into album art, the downloads, or other mechanics. That entity may also take a portion of the fee paid by the advertiser. As described in greater detail below, the disclosure can be practiced to even greater advantage by referring to demographic information derived from social network providers for selecting which messages (e.g., advertisements) to add to which downloads.

Using the teachings of this disclosure, a method and media are provided that allows advertisers to pay per download to ‘sponsor’ MP3 downloads. This allows musicians (labels, producers) to give music away for free and still make money by way of ‘sponsorships.’ The method can be implemented in a software program.

### DESCRIPTION OF DRAWINGS

To further advantages and features of the present disclosure, a more particular description of the invention will be rendered by reference to specific embodiments thereof which are illustrated in the appended drawings. It is appreciated that these drawings are not to be considered limiting in scope. The invention will be described and explained with additional specificity and detail through the use of the accompanying drawings in which:

FIG. 1 shows one embodiment of the process of creating a modified cover artwork.

FIG. 2 shows an alternate embodiment of the process of creating a modified cover artwork.

FIG. 3 shows one embodiment of a modified cover artwork displaying a message.

FIG. 4 shows one embodiment of the process involved with providing advertising services as disclosed in the present application

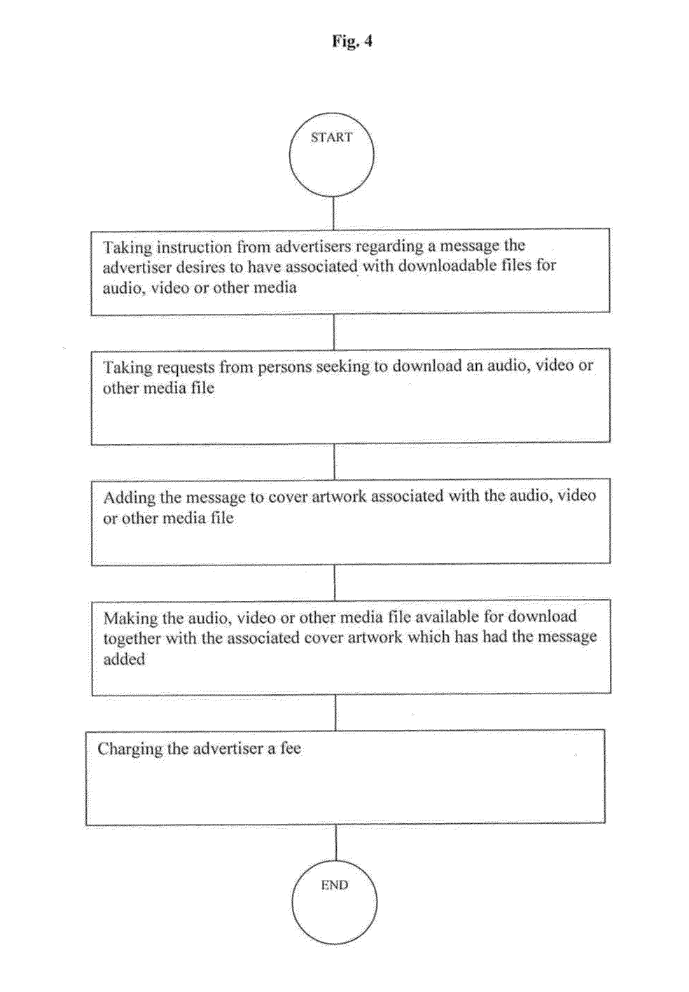

### DETAILED DESCRIPTION

The following provides an exemplary description of the medium and methods of this disclosure. It is not to be limited to the particular embodiments discussed.

The disclosure teaches a medium and methods that provide a source of brand advertising that uses music to emotionally connect the consumer with the brand or message of an advertiser or other entity that seeks to disseminate a message. The disclosure provides for creating a mutually beneficial triangle of stakeholders that facilitates quality brand placement for advertisers, revenue for musicians, and lower cost (or free) music. These can be accomplished using MP3 (or other file format) album art as the platform for individual track or album-wide advertiser-paid sponsorships. Using this method, monetization of music can be shifted from consumer-provided revenue to advertiser-provided revenue. In accordance with the disclosure, a “pay per download” advertising model is provided that can serve to rival the current “pay per click” and “pay per impression” advertising models.

### Method of Creating an Advertising Medium

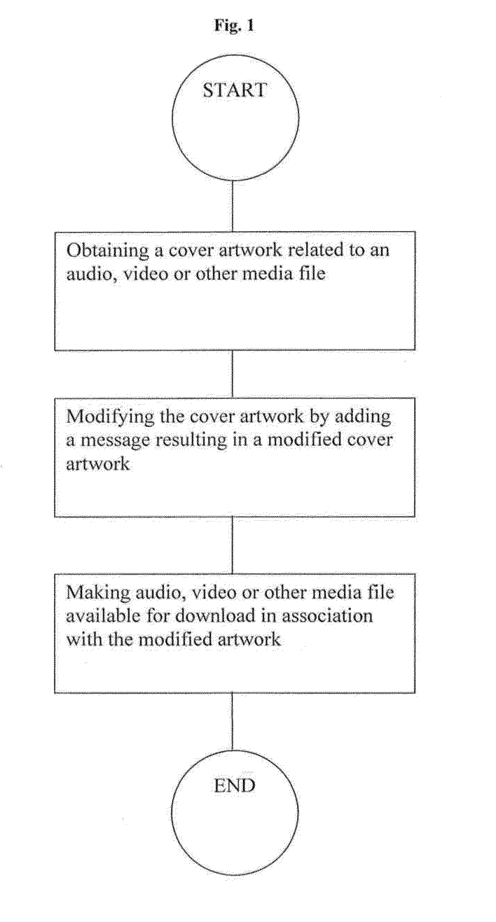

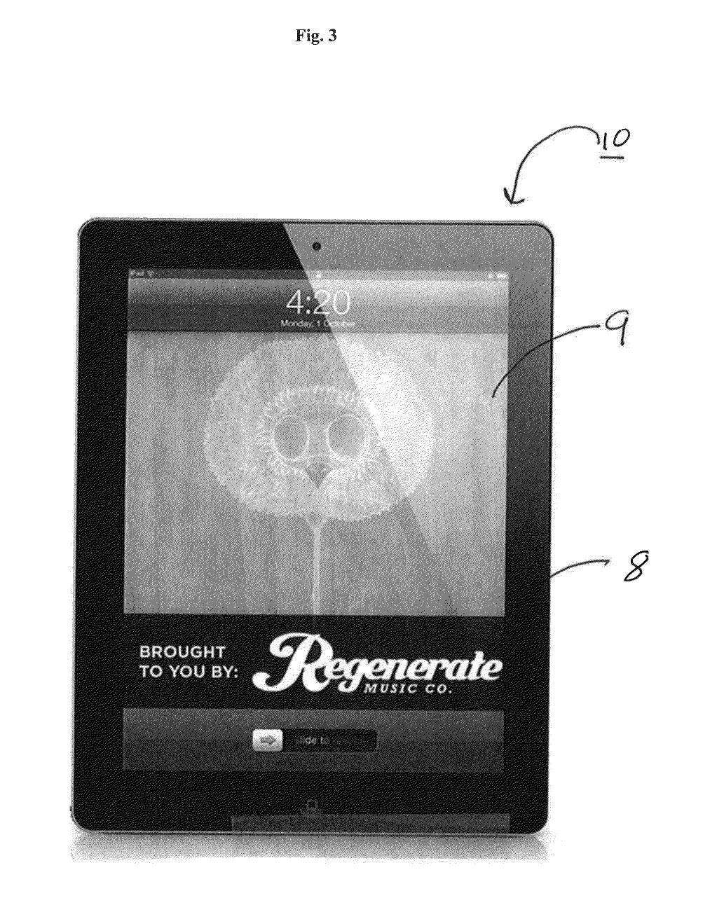

A method of creating an advertising medium 2 is provided, comprising: obtaining cover artwork 4 related to an audio or video file (or other media) 6; prior to or in connection with making the audio or video file 6 available for download, modifying the cover artwork 4 by adding to the cover artwork a message 8, whereby a modified cover artwork 9 results; making the audio, video, or other media file 6 available for download in association with the modified cover artwork 9. One embodiment of this process is illustrated in FIG. 1. In connection with the method, the message 8 may be the name of an advertiser, or an advertisement, or another message for which an entity pays as shown in FIG. 3. The message 8 may be embedded within the modified cover artwork 9. The message 8 may be overlaid upon the modified cover artwork 9, in Which case it may become a layer of the modified cover artwork 9, or it may be in a flat file with the modified cover artwork 9 such that it cannot be easily removed to reveal the un-modified version of the cover artwork 4. The modified cover artwork 9 may be a part of the audio, video, or other media file 6. Alternately, the modified cover artwork 9 may be merely associated with the audio, video, or other media file 6. In some cases, the message 8 may be substantially non-removable. It may be desirable to make a message 8 non-removable by causing the file to become less useful if the message 8 is removed. In many eases the modified cover artwork 9 will display every time (or nearly every time) the audio, video, or other media file 6 is accessed in the normal course in the future.

In some embodiments, the process of creating the advertising media further comprises creating a database associating (a) identification information for at least one of one artist with (b) additional information comprising at least information selected from the group consisting of information about said artist, information about a work of the artist, the genre of work created by the artist, and information about one of the downloadable media files containing a work of said artist.

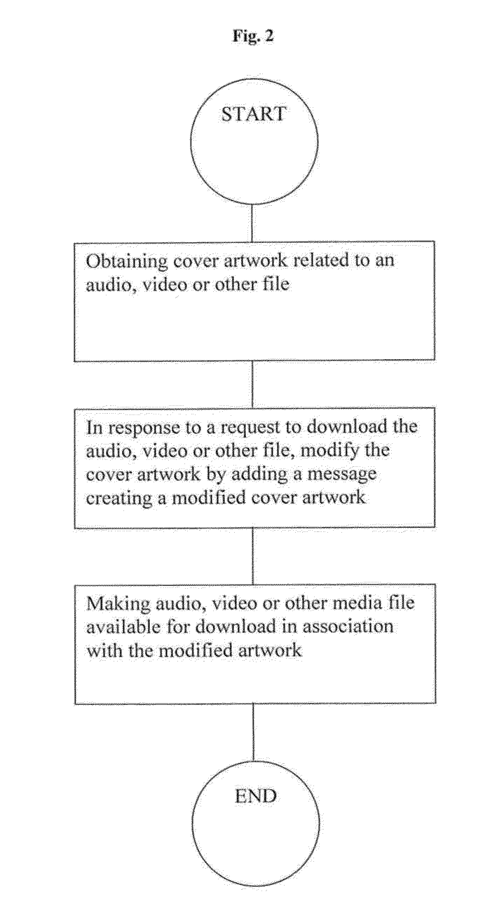

In some embodiments, as illustrated in FIG. 2, the modification of the cover artwork 4 may occur in response to a download request. The modification made in response to a given download request may be different from the modification made in response to a different download request that is made at a different time, or by a different person, or with different parameters. The modification can be “on the fly,” such that it is done in time with the requests. Alternately, the modification may be done prior to a given request, with the appropriate modified file being selected When an appropriate request is received.

The particular modification made (e.g., the particular message added as part of the modification, or the location or other characteristics of the addition) may be selected with reference to demographics. Some messages 8 that are to be added to the audio, video, or other media file 6 may be more appropriate or desirable for display to a person with particular tastes or characteristics. For example, if the message 8 is an advertisement, the advertiser may request that its message be added in cases in which the download is anticipated to be received by a person of a given age group. Other advertisers may care about other demographic characteristics, including but not limited to musical taste, gender, age, profession, number of “friends” in social network, geography, or any other parameter for which demographics may be available.

The method may involve determining demographic parameters by reference to third party databases. Third party databases may advantageously be derived from a social network. Social networks (or social networking services) are an online platform focused on building social relationships among people who share common interests, backgrounds or other real-life connections. Popular examples include “Facebook”, “Twitter” and “Myspace.” Many social networks collect demographic data on their users. Such demographic data may include, but is not limited to the age, sex, religious preference, geographic location and any special interests. In a particular implementation, the demographic information may be sourced by employing a connector or API (application programming interface) that is made available by the social network provider or other provider of third party databases. In one such implementation, the method may involve requiring or permitting the user (the person to whom a download is made available) to provide login credentials or other authorization for access to the social network or other third party resource. In some cases, the credentials or other information may be associated by the operator of the method with other credentials or authorizations, for the same or other sources of demographic information. For example, the operator may establish a sign-on or credentialing system in which users must log into a website or other system in order to download the audio, video, or other media file. Once logged in, if the user has provided credentials or other authorizations for one social network provider or for accessing information from a third party database, the operator may link (or otherwise associate) those provided credentials or other authorizations with the login information used by the user to access the operator's system, for use in future access to the social network or other provider. Additionally, if the user has provided credentials or authorizations for multiple social network or other providers, the operator may associate some or all of those with the user's login, such that the operator, and if desired the user, may access any or all of those providers in connection with the user's account.

Advantageously, a software program can be implemented to practice the method. The software would employ a computing processor and hardware that is customized with appropriate graphics capabilities for rendering new album cover art.

### An Advertising Medium

An advertising medium 10 is provided, comprising: modified cover artwork 9 (e.g., for audio or video files) that includes embedded messages 8 of or referring to a third party. The third party may be an advertiser or other entity that is not the artist, the producer, or the “label” (the music label or the video studio). The modified cover artwork 9 may be associated with an MP3 or other audio tile format. The modified cover artwork 9 may be associated with an MP4 or other video file format. The modified artwork 9 may be downloadable with or as part of a downloadable file containing the audio or video (or other) file 6. The modified cover artwork 9 may be a customized artwork that is created with reference to the demographics of the person downloading the file. Advantageously, the artwork may be configured to render the message 8 not easily removable. The modified cover artwork 9 may be created in connection with the method taught above, and therefore the disclosure above may be applicable to the advertising medium discussed in this paragraph.

In one embodiment, a database of advertising media 10 is created comprising a plurality of modified cover artwork 9 which further comprises embedded messages 8 referring to a third party. The particular message 8 to be embedded on the cover artwork is determined by sourcing demographic data from social networks (as discussed herein).

### A Method of Providing Advertising Service

A method of providing advertising services is provided, comprising: taking instruction from advertisers regarding a message the advertiser desires to have associated with downloadable files for audio, video, or other media; taking requests from persons seeking to download an audio, video, or other media file; adding the message to cover artwork associated with the audio, video, or other media file; making the audio, video, or other media file available for download together with the associated cover artwork which has had the message added; and, charging the advertiser a fee. The fee may be based on the number of downloads. Additionally or alternately, the fee may be based on the demographic data associated with the person that downloads the file. The implementation may require advertisers to pay more for messages added to downloads made in connection with certain demographics than for downloads made in connection with other demographics. The operator of the method may disburse a portion of the fee to an entity that controls rights (e.g., distribution rights, copyright, patent rights, etc., such as an artist, producer, or music label) associated with the audio, video, or other media file. In such a way, both the operator of the method and the entity that controls rights in the file receive monetary reward for the process, while the advertiser receives the advertising benefit. In some embodiments, the fee charged may also or alternately be set with reference to the actual, statistical, or anticipated number of times the file is copied or redistributed after the file is downloaded in connection with the method. In such a way, a greater fee can he charged for a popular audio, video, or other media file that is expected to be the target of substantial piracy or unauthorized redistribution.

This disclosure contemplates use of the methods taught above wherein the audio, video, or other media file to which the message is added is a particular file selected by the advertiser. Alternately, this disclosure contemplates use of the methods wherein the audio, video, or other media file is selected by reference to demographic information. In such an implementation, the advertiser may be permitted to select the demographic information that is most of interest to the advertiser, prior to the downloads being made available. In sonic cases, the demographic information may be derived from social network resources.

It will be appreciated that the media and method taught herein maintains value for the advertiser even in the event the downloaded file is “pirated” or otherwise further distributed without permission. This is because the message is embedded within the artwork associated with the file, and therefore even unauthorized downloads serve to further disseminate the message. Thus, even “theft” is advantageous to the advertiser's message, because every additional download and distribution—even if not authorized—increases the exposure (the “number of eyes”) that the advertiser benefits from. Advantageously, a software program can be implemented to practice the method. The software would employ a computing system including computing processor and hardware that is customized with appropriate graphics capabilities for rendering new album cover art.

A computer system could include, for example, one or more processors that are connected to a communication bus and memory. Memory may also include a main memory, preferably a random access memory (RAM), and can also include a secondary memory. The secondary memory can include, for example, a hard disk drive and/or a removable storage drive. The removable storage drive reads from and/or writes to a removable storage unit in a well-known manner. The removable storage unit, represents a floppy disk, magnetic tape, optical disk, and the like, which is read by and written to by the removable storage drive. The removable storage unit includes a processor readable storage medium having stored therein computer software and/or data.

A software program (also called computer control logic) is stored in the main memory and/or secondary memory. Software can also be received via the communications interface. Such software programs, when executed, enable the computer system to perform certain features of the present invention as discussed herein. In particular, the software, when executed, enable a control processor to perform and/or cause the performance of features of the present invention.

The method of providing advertising services may be practiced in connection with the other methods and the advertising medium taught above, and therefore the disclosure above may be applicable to the method of providing advertising services discussed in this section.

In one embodiment, the methods taught herein may be practiced as an ‘on the fly’ ad insertion method for associating advertisements or other messages with album cover art, in stepwise fashion as follows:
1. A user receives a link to download a free digital music file (or collection of files) and clicks on the link. The source of the link may be from an advertiser, from the music artist, from social network, or from any other source.
2. A server that has been configured for use in the method receives the request sent by the user “clicking” on the link.
3. The server matches the demographics of the user (which may be derived from social network information as discussed above, or in an alternate, may be from a user-generated profile) to a number of relevant advertisements or messages in a system.
4. The advertisements or messages may be first filtered by the timeframe the advertiser has set for each advertisement or message. Only those whose date range is applicable at the time of download pass this filter.
5. The remaining ads may be filtered by each available demographic of the user until the most relevant advertisements or messages are left.
6. The server chooses an advertisement or message from the filtered list, taking into account the price of the advertisement or the budget amount remaining, for insertion into the digital music file.
7. The server then opens a copy of the original graphic artwork (e.g., the album cover artwork) for the digital music file and inserts the graphic associated with the selected advertisement or message into the artwork file.
8. The server makes a copy of the digital music file and inserts the new artwork file (which now contains the inserted advertisement or message) into the metadata of the digital music file. Alternately, the artwork file may be associated with the music file in any other appropriate way, such as by reference or link. If the file format supports a “notes” or “lyrics” metadata field, a URL for the advertiser is added to that field.
9. The server saves the copy of the digital music file, with the customized advertising in place, then using standard network protocols delivers this file to the user.

### CONCLUSION

The foregoing description illustrates and describes the processes, machines, manufactures, compositions of matter, and other teachings of the present disclosure. Additionally, the disclosure shows and describes only certain embodiments of the processes, machines, manufactures, compositions of matter, and other teachings disclosed, but, as mentioned above, it is to be understood that the teachings of the present disclosure are capable of use in various other combinations, modifications, and environments and are capable of changes or modifications within the scope of the teachings as expressed herein, commensurate with the skill and/or knowledge of a person having ordinary skill in the relevant art. The embodiments described hereinabove are further intended to explain certain best modes known of practicing the processes, machines, manufactures, compositions of matter, and other teachings of the present disclosure and to enable others skilled in the art to utilize the teachings of the present disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein.

We claim:

1. A method of distributing downloadable media, comprising:
a. collecting a plurality of downloadable media files from a plurality of artists, at least one of the downloadable media files being associated with an item of visual artwork;
b. receiving from an advertiser an order for promotional services;
c. selecting at least one downloadable media file to associate with said advertiser;
d. creating a modified item of visual artwork by adding an advertising message relating to the advertiser to the item of visual artwork associated with the selected downloadable media file;
e. collecting demographic information about a recipient;
f. delivering to the recipient a downloadable copy of the downloadable media file and the modified item of visual artwork containing the advertising message; and
g. charging a fee to the advertiser.

2. The method of claim 1, wherein at least one of the downloadable media files is a music file.

3. The method of claim 2, wherein at least one of the items of visual artwork is a file containing album cover art related to the music file.

4. The method of claim 1, further comprising creating a database associating (a) identification information for at least one of said artists with (b) additional information comprising at least information selected from the group consisting of information about said artist, information about a work of the artist, the genre of work created by the artist, and information about one of the downloadable media files containing a work of said artist.

5. The method of claim 4, wherein the step of selecting at least one downloadable media file comprises selecting an artist to associate with the advertiser.

6. The method of claim 5, wherein the process of selecting an artist comprises using a computer to query the database for artists about whom information matches parameters designated by or for the advertiser.

7. The method of claim 1, wherein the demographic information about the recipient is collected from a social media service.

8. The method of claim 7, wherein the parameters designated by or for the advertiser are selected with reference to the collected demographic information

9. The method of claim 1 wherein one or more of the following steps is performed proximate in time to a client-server request for the downloadable media file: creating a modified item of visual artwork, delivering to a recipient, or charging a fee to the advertiser.

10. The method of claim 1 wherein one or more of the following steps is performed after receipt of a client-server request for the downloadable media file: creating a modified item of visual artwork, delivering to a recipient, or charging a fee to the advertiser.

11. The method of claim 1 wherein the step of creating a modified item of visual artwork is performed multiple times.

12. The method of claim 11 wherein the step of creating a modified item of visual artwork occurs at different times and with different results for different recipients.

13. The method of claim 1, wherein the process of selecting at least one downloadable media file comprises using a computer to choose among the available downloadable media files by checking for relationships between information about the available downloadable media files and the demographic information.

14. The method of claim 1, wherein the method further comprises saving the modified item of visual artwork as a new file.

15. The method of claim 15, wherein the advertising message is embedded within the modified item of visual artwork in such a manner that the advertising message cannot be removed or changed after delivery to the recipient without editing the downloaded file.

16. The method of claim 16, wherein the recipient receives the downloadable media file free of charge.

17. A computer implemented method of distributing a downloadable music file, comprising:
a. collecting a plurality of downloadable music files from a plurality of artists, at least one of the downloadable music files being associated with an album cover art;
b. creating a database associating (a) identification information for at least one of said artists with (b) additional information comprising at least information selected from the group consisting of information about said artist, information about a work of the artist, the genre of work created by the artist, and information about one of the downloadable music files containing a work of said artist;
c. receiving from an advertiser an order for promotional services;
d. collecting demographic information about a recipient from a social media service;
e. selecting at least one downloadable music file to associate with said advertiser, wherein said selection is accomplished at least in part by querying the database for artists about whom information matches parameters designated by or for the advertiser;
f. creating a modified item of visual artwork by adding an advertising message relating to the advertiser to the item of visual artwork associated with the selected downloadable music file, wherein the advertising message is embedded within the modified item of visual artwork in such a manner that the advertising message cannot be removed or changed after delivery to the recipient without editing the downloaded file;
g. saving the modified item of visual artwork as a new file;
h. delivering to the recipient a downloadable copy of the downloadable media file and the item of modified visual artwork containing the advertising message; and
i. charging a fee to the advertiser.
wherein one or more of the following steps is performed proximate in time to a client-server request for the downloadable media file: creating a modified item of visual artwork, delivering to a recipient, or charging a fee to the advertiser.

18. An apparatus for monetizing the distribution of downloadable media, wherein the apparatus comprises a software or firmware encoded on non-transitory media operated on by a processor, said processor being programmed to perform the steps of:
a. collecting a plurality of downloadable media files from a plurality of artists, at least one of the downloadable media files being associated with an item of visual artwork;
b. receiving from an advertiser an order for promotional services;
c. selecting at least one downloadable media file to associate with said advertiser;
d. creating a modified item of visual artwork by adding an advertising message relating to the advertiser to the item of visual artwork associated with the selected downloadable media file;
e. collecting demographic information about a recipient;
f. delivering to the recipient a downloadable copy of the downloadable media file and the item of modified visual artwork containing the advertising message; and
g. charging a fee to the advertiser.
